(19) United States
(12) Patent Application Publication
(10) Pub. No.: US 2019/0202510 A1
(43) Pub. Date: Jul. 4, 2019

(54) SUPPORT DEVICE FOR A TRACKED VEHICLE; CONVERSION KIT FOR A TRACKED VEHICLE AND TRACKED VEHICLE COMPRISING SAID SUPPORT DEVICE

(71) Applicant: PRINOTH S.P.A., Vipiteno (IT)

(72) Inventors: Martin Kirchmair, Pfons (AT); Gregor Maurer, Vipiteno (IT)

(21) Appl. No.: 16/330,305

(22) PCT Filed: Sep. 15, 2017
(86) PCT No.: PCT/IB2017/055600

§ 371 Date: Mar. 4, 2019

(30) Foreign Application Priority Data
Sep. 15, 2016 (IT) 102016000093165

(51) Int. Cl. B62D 55/24; B62D 55/14; B62D 55/104; B62D 55/30; B62D 55/10; B62D 55/32

(52) U.S. Cl. CPC B62D 55/24; B62D 55/14; B62D 55/104; E01H 4/02; B62D 55/10; B62D 55/32; B62D 55/30

(57) ABSTRACT

Support device for a tracked vehicle, in particular for a tracked vehicle configured for preparing ski slopes, wherein the tracked vehicle comprises a track comprising at least a first belt and a plurality of transverse metal elements, fixed to at least the first belt; a front wheel; and a rear wheel; the support device comprising at least a first plurality of support wheels configured to be arranged between the rear wheel and the front wheel inside the track, and a second belt closed in a loop and stretched around the plurality of support wheels and configured to be arranged inside the track; the support wheels and the second belt being shaped so as to provide a shape coupling, such as between an inner face of the second belt and an outer face of the support wheels; the second belt, such as an outer face of the second belt, being configured to be arranged in contact with an inner face of the track.

### PRIORITY CLAIM

This application is a national stage application of PCT/IB2017/055600, filed on Sep. 15, 2017, which claims the benefit of and priority to Italian Patent Application No. 102016000093165, filed on Sep. 15, 2016, the entire contents of which are each incorporated by reference herein.

### TECHNICAL FIELD

The present disclosure relates to a support device for a tracked vehicle; a conversion kit for a tracked vehicle; and a tracked vehicle, in particular configured for preparing ski slopes, comprising said support device.

### BACKGROUND

A track of a tracked vehicle for preparing ski slopes generally comprises a plurality of bars arranged transversely to the direction of travel and a plurality of belts made of an elastomeric material which extend parallel to the direction of travel and to which the transverse bars are fixed so as to be evenly spaced with respect to one another along the direction of travel. Thus, the track has cavities between adjacent transverse bars and between adjacent belts. The track extends from a rear wheel to a front wheel of the tracked vehicle and is looped around the rear wheel and the front wheel. The rear wheel is generally a drive wheel and is coupled to the track. The lower portion of the track that comes into contact with the ground is the so-called traction portion of the track. Tracked vehicles are generally provided with support wheels which are arranged between the rear wheel and the front wheel inside the loop of the track with the function of holding the traction portion in contact with the ground and distributing the mass of the tracked vehicle along the traction portion.

In use, the support wheels turn inside the track, moving between adjacent transverse bars and the respective cavities. In certain circumstances, as the support wheels turn inside the track, they generate vibrations, which in turn reduce the adherence between the support wheels and the track. The reduction in adherence between the support wheels and the track could undermine the distribution of the weight on said track which, in turn, could reduce the adherence of the track to the ground or to the snow, in particular on slopes. Moreover, the vibrations that are generated impair comfort, shorten the life of the suspensions, and accelerate wear on the actual vehicle.

### SUMMARY

The purpose of the present disclosure is to provide a support device of the type described above that reduces certain of the inconveniences of certain of the prior art.

According to the present disclosure there is provided a support device for a tracked vehicle, in particular for a tracked vehicle configured for preparing ski slopes, wherein the tracked vehicle comprises a track comprising at least a first belt and a plurality of transverse metal elements, fixed to at least the first belt; a front wheel; and a rear wheel; the support device comprising a first plurality of support wheels arranged between the rear wheel and the front wheel inside the track, and a second belt configured to be closed in a loop and stretched around the plurality of support wheels and arranged inside the track; the support wheels and the second belt being shaped so as to provide a shape coupling, such as between an inner face of the second belt and an outer face of the support wheels; the second belt, such as an outer face of the second belt, being configured to be arranged in contact with an inner face of the track.

It should thus be appreciated that the present disclosure provides that it is possible to reduce the oscillations that occur on the support wheels in certain of the prior art solutions and the oscillations transmitted to the frame.

According to one embodiment of the disclosure, the track comprises guides for the support wheels which are connected to the transverse elements and which face towards the inside of the track, the guides being arranged in contact with the second belt.

According to one embodiment of the disclosure, the first plurality of support wheels comprises a pair of support wheels; and the second belt is closed in a loop and stretched around the pair of support wheels; the pair of support wheels and the second belt being shaped so as to provide a shape coupling, such as between the inner face of the second belt and the outer face of the support wheels; the second belt (and in certain embodiments the outer face of the second belt), being configured to be arranged in contact with an inner face of the track.

According to one embodiment of the disclosure, the support wheels have a first outside diameter that is comprised between 80% and 135% of the value of a second outside diameter of the front wheel (and in certain embodiments between 100% and 120% of the second diameter of the front wheel).

According to one embodiment of the disclosure, the support wheels have a first outside diameter that is comprised between 80% and 130% of the value of a third maximum outside diameter of the rear wheel (and in certain embodiments between 90% and 105% of the third diameter of the rear wheel).

According to one embodiment of the disclosure, each support wheel comprises recesses which extend in an annular manner around the support wheel to provide the shape coupling, wherein in certain embodiments the support wheel comprises a plurality of recesses.

According to one embodiment of the disclosure, the second belt comprises at least one protrusion which extends along the inner face, such as longitudinally to the inner face, of the second belt to provide the shape coupling.

According to one embodiment of the disclosure, the second belt has protrusions evenly distributed along the inner face of the second belt which extend longitudinally to the inner face of the second belt; and the support wheels comprise recesses evenly distributed around the rotation axis of the support wheel with the same distribution pitch as that of the protrusions; each recess being sized to house a protrusion.

According to one embodiment of the disclosure, the support structure comprises a structure on which the support wheels are mounted and having a rotatable coupling configured to be connected to the frame of the tracked vehicle. In certain such embodiments, the plurality of support wheels is formed by a pair of support wheels borne by the structure and mounted at the ends of the structure.

According to one embodiment of the disclosure, the plurality of support wheels are borne by a rocker arm; the rocker arm being configured to be coupled to the frame of the tracked vehicle such as by a crank.

According to one embodiment of the disclosure, the second belt comprises a composite elastomeric material.

According to one embodiment of the disclosure, the second belt has an outer face configured to couple with the inner face of the track; such as the outer face of the second belt is smooth. In certain embodiments, the outer face of the second belt is configured to be in contact with the guides.

According to one embodiment of the disclosure, the second belt has an outer face configured to couple with the inner face of the track. In certain embodiments, the outer face of the second belt comprises diagonal or longitudinal teeth.

According to one embodiment of the disclosure, the support device comprises a belt tensioning device coupled to the second belt to keep the second belt tight.

According to one embodiment of the disclosure, the support wheels are made of a material selected from a group comprising Teflon, metal, plastic, such as with an amount of elastomeric material.

According to one embodiment of the disclosure, the support device comprises a belt tensioning device configured to adjust the tension of the second belt between the plurality of support wheels.

A further purpose of the present disclosure is to provide a conversion kit for a tracked vehicle that reduces certain of the inconveniences of certain of the prior art.

According to the present disclosure there is provided a conversion kit for a tracked vehicle, in particular for a tracked vehicle configured for preparing ski slopes, wherein the tracked vehicle comprises a rear wheel, a front wheel, and another plurality of support wheels arranged between the rear wheel and the front wheel, facing towards an inner face of the track; the conversion kit comprising a support device as disclosed herein; wherein the plurality of support wheels are configured to replace the other plurality of support wheels.

A further purpose of the present disclosure is to provide a tracked vehicle that reduces certain of the inconveniences of certain of the prior art solutions.

According to the present disclosure there is provided a tracked vehicle, in particular for preparing ski slopes, the tracked vehicle comprising:
a frame;
two rear wheels supported by the frame;
two front wheels supported by the frame;
two tracks, each wound around a respective rear wheel and a front wheel and comprising a traction portion; and
at least one support device (as described herein) for each track; wherein each support device is arranged inside the respective track between the respective rear wheel and the respective front wheel.

According to certain embodiments of the present disclosure, the second belt of the support device is placed in contact with an inner face of the track.

A further purpose of the present disclosure is to provide a method of conversion of a tracked vehicle that reduces certain of the inconveniences of certain of the prior art solutions.

According to the present disclosure, there is provided a method of conversion of a tracked vehicle comprising a frame; two front wheels borne by the frame; two rear wheels borne by the frame; two tracks, wherein each track is looped around a respective front wheel and around a respective rear wheel; another plurality of support wheels borne by the frame for each track arranged inside the track and between the respective front wheel and the respective rear wheel; the method comprises the steps of removing the other plurality of support wheels from the frame and of coupling to the frame at least one support device for each track between the respective front wheel and the respective rear wheel and of housing the support device inside the track.

Additional features are described in, and will be apparent from the following Detailed Description and the figures.

### BRIEF DESCRIPTION OF THE DRAWINGS

Further characteristics and advantages of the present disclosure will become clear from the following description of non-limiting embodiments thereof, with reference to the accompanying figures, in which:

FIG. 1 is a side elevation view, with some parts removed for the sake of clarity, of a tracked vehicle configured for preparing ski slopes and provided with a support device of the type described above;

FIG. 2 is a side elevation view on an enlarged scale of a detail of FIG. 1.

FIG. 3 is an enlarged side elevation view of a detail of FIG. 1, with some parts removed for the sake of clarity; and

FIG. 4 is a cross-sectional view of FIG. 3, with some parts removed for the sake of clarity and on an enlarged scale.

### DETAILED DESCRIPTION

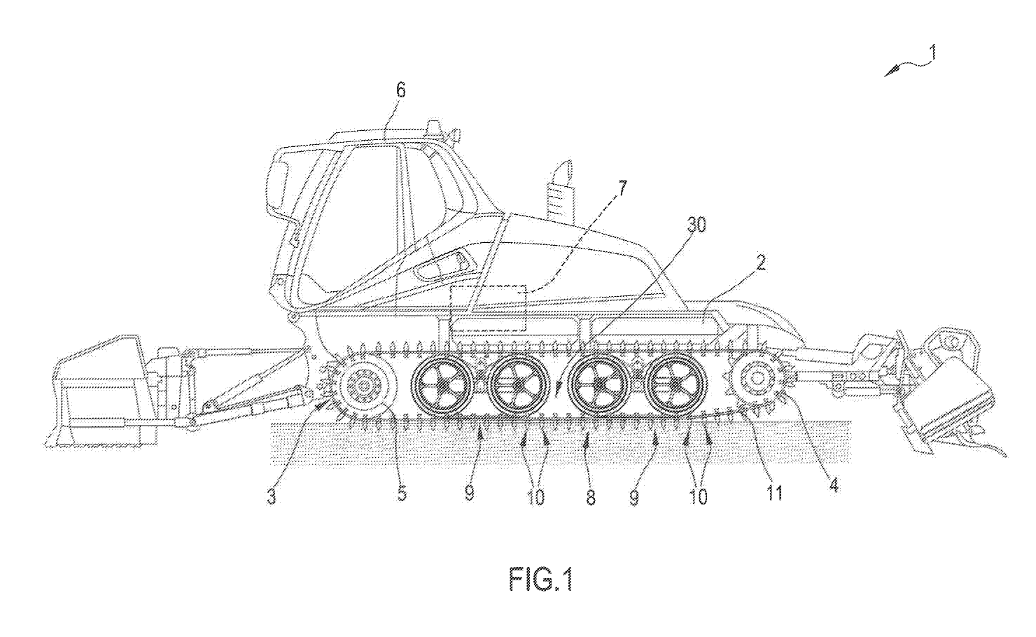

Referring now to the example embodiments of the present disclosure illustrated in FIGS. 1 to 4 and specifically with reference to FIG. 1, designated as a whole by number 1 is a tracked vehicle configured to prepare ski slopes. The tracked vehicle 1 comprises a frame 2; two tracks 3 (only one of which is illustrated in FIG. 1); two rear wheels 4 (only one of which is illustrated in FIG. 1) rotatable about an axis of rotation A1; two front wheels 5 (only one of which is illustrated in FIG. 1) rotatable about an axis of rotation A2; a cab 6; and an engine 7. The rear wheels 4 are drive wheels actuated independently of one another by actuators, such as of the hydraulic or electric or mechanical type, and are coupled to the respective tracks 3.

Each track 3 is looped around a respective one of the two rear wheels 4 and a respective one of the two front wheels 5. In other words, the rear wheel 4 and the front wheel 5 engage the track 3, along an inner face 30 of the track 3, in respective end portions of the track 3. The track 3 comprises an upper section and a lower section along which a traction portion 8 extends. In use, the traction portion is in contact with the ground to discharge the mass of the tracked vehicle 1 and the tractive force transmitted by the engine 7 through a kinematic chain to the rear wheels 5.

The tracked vehicle 1 comprises two support devices 9 for each track 3. In other words, each track 3 cooperates with two support devices 9 arranged in succession between the front wheel 5 and the rear wheel 4. The support devices 9 are arranged inside the loop of the respective track 3 between the rear wheel 4 and the respective front wheel 5 to distribute the mass of the tracked vehicle 1 along the traction portion 8 of the track 3 and compress the traction portion 8 of said track 3 against the ground to achieve relatively greater adherence to the ground and reduce any slipping of the track 3 on the ground. The support devices 9 are arranged in contact with the inner face 30 of the respective track 3.

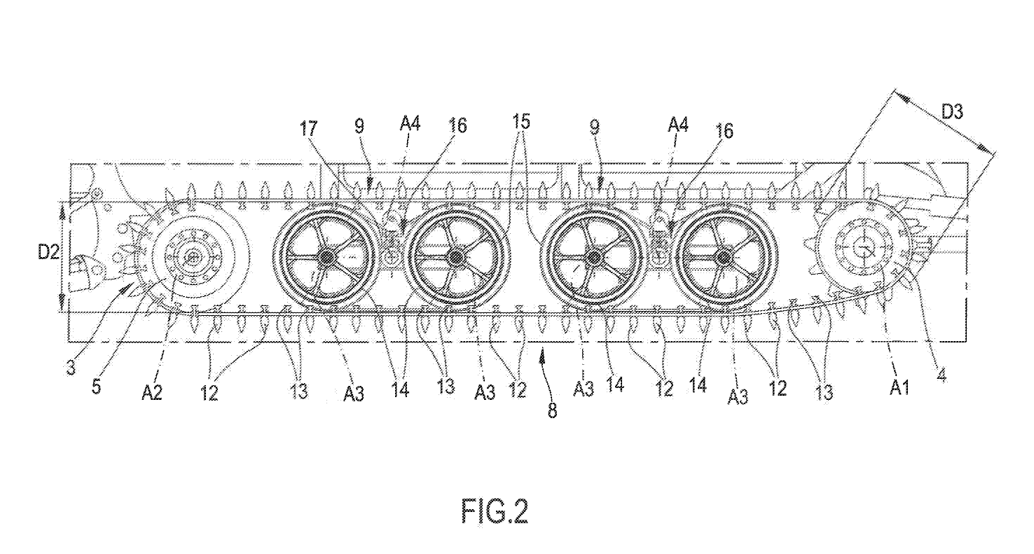

With reference to FIGS. 2 to 4, each track 3 comprises a plurality of elements 10 arranged transversely to the direction of travel and a plurality of belts 11 made of an elastomeric material, in particular rubber, to which the transverse elements 10 are fixed spaced apart along the direction of travel. According to one embodiment, the belts 11 comprise a composite elastomeric material, for example with internal fibres.

Each transverse element 10 comprises a grouser 12 and a guide 13 which are arranged on opposite sides of the belts 11. Moreover, each grouser 12 is connected to the belts 11 by bolted metal plates. Thus, the grousers 12 also have the function of keeping the belts 11 apart from one another. With reference to FIGS. 1, 2 and 4, the belts 11 are looped and adjacent to one another along an axis parallel to the axis A1 or A2. According to certain embodiments, each track 3 comprises a number of belts 11 that is variable between two and eight. According to an alternative embodiment, each belt 11 comprises portions of belt which joined together form the looped belt 11.

Each support device 9 comprises a plurality of support wheels 14, in particular two wheels 14, having an outside diameter D1 which is a function of the outside diameter D2 of the front wheel 5; a belt 15 wound around the plurality of wheels 14 and stretched between the wheels 14; and a structure 16 configured to support the plurality of wheels 14 and to push the plurality of wheels 14 and the belt 15 against the inside of the track 3 and along the traction portion 8 of the track 3. The two wheels 14 of each support device 9 are aligned along the direction of travel of the tracked vehicle 1.

The wheel 14 is made of Teflon.

According to an alternative embodiment, the wheel 14 is made of metal.

According to an alternative embodiment, the wheel 14 is made of plastic.

According to an alternative embodiment, the wheel 14 comprises an amount of elastomeric material.

Materials such as Teflon or metal or plastic are chosen to reduce the friction between the belt 15 and the wheels 14 in order to reduce wear and the amount of heat that is generated.

The guides 13 are coupled to the support wheels 14 to keep the support wheels 14 in the correct position inside the respective track 3.

In more detail, the wheels 14 have an outside diameter D1 that is comprised between 80% and 135% of the value of the outside diameter D2 of the front wheel 5; in particular between 100% and 120% of the outside diameter D2 of the front wheel 5.

According to an alternative embodiment, the wheels 14 have the outside diameter D1 which is a function of an outside diameter D3 of the rear wheel 4. In more detail, the wheels 14 have an outside diameter D1 that is comprised between 80% and 130% of the value of the outside diameter D3 of the rear wheel 4 (and in certain embodiment, between 90% and 105% of the outside diameter D3 of the rear wheel 4).

According to an alternative embodiment, the wheels 14 have the outside diameter D1 which is a function of the outside diameter D2 of the front wheel 5 and of the outside diameter D3 of the rear wheel 4. In greater detail, the wheels 14 have the outside diameter D1 that is comprised between 80% and 135% of the value of the outside diameter D2 of the front wheel 5, in particular between 100% and 120% of the outside diameter D2 of the front wheel 5; and comprised between 80% and 130% of the value of the outside diameter D3 of the rear wheel 4 (and in certain embodiments between 90% and 105% of the outside diameter D3 of the rear wheel 4). The outside diameter refers to the maximum outside diameter of the wheel.

The wheels 14 are arranged inside the loop of the track 3 and each has an axis of rotation A3 parallel to the axis of rotation A1 of the rear wheel 4.

The plurality of wheels 14 are mounted on the respective structure 16. In other words, each pair of wheels 14 is mounted on the respective structure 16. In more detail, the structure 16 is a rocker arm that houses one wheel of the pair of wheels 14 on its opposite ends. The structure 16 comprises at least one beam 17 for supporting the wheels 14 at the ends, in particular one wheel 14 for each end of the beam 17; and a rotatable coupling 18 that connects the beam 17 to the frame 2 of the tracked vehicle 1.

In more detail, the rotatable coupling 18 comprises a crank (not illustrated in the accompanying figures) which rotates about an axis parallel to the axis A4. The crank is joined to the frame 2 by a bearing or a bushing (not illustrated in the accompanying figures) that enables the rotation about the axis parallel to the axis A4. Furthermore, the crank is connected to a shock-absorbing suspension device.

The rotatable coupling 18 further comprises a bearing, or a joint or a bushing, and stops. The rotatable coupling 18 enables the crank to rotate with respect to the frame 2 about the axis A4.

With reference to FIG. 1, each track 3 comprises two support devices 9 arranged in a row, in other words the axis A2 and the axes A4 are parallel to one another.

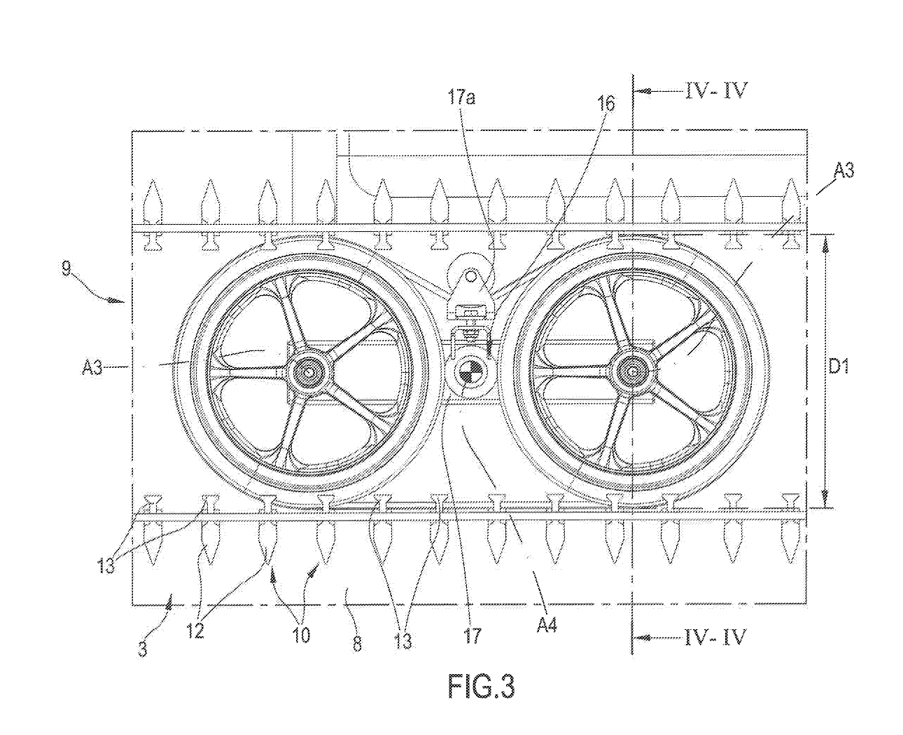

With reference to FIG. 3, the belt 15 is made of an elastomeric material and fabric or of an elastomeric material only and is placed directly in contact with the guides 13. According to one embodiment, the belt 15 is made of a composite elastomeric material.

The belt 15 is wound inside the loop of each belt 11. In addition, the belt 15 is placed in contact with the inner face 30 of the track 3. In use, the belt 15 defines a sliding surface for the support wheels 14. This reduces the vibration of the tracked vehicle.

In other words, each belt 11 describes a respective inner area, the belt 15 is housed inside the inner area described by the belt 11. In more detail, the belts 11 are arranged between the guides 13 of the track 3 and the respective grousers 12. With reference to FIGS. 2 and 3, the belt 15 is arranged between the wheel 14 and the guide 13. In other words, the belt 15 is arranged between the wheel 14 and the inside of the track 3. The belt 15 is inscribed within a closed area described by the track 3.

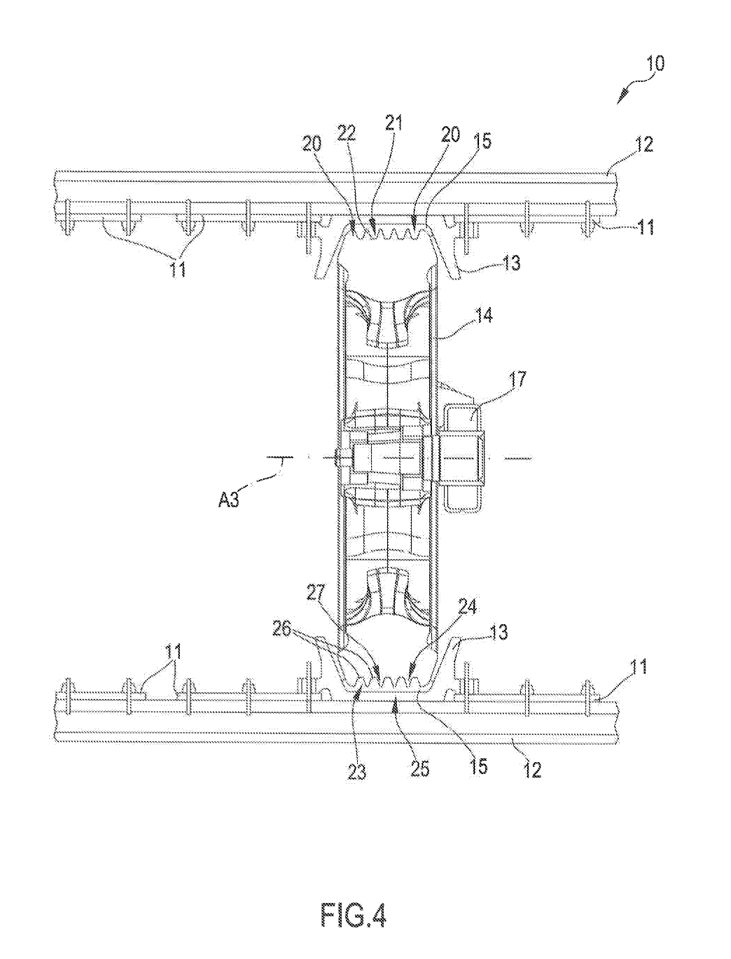

With reference to FIG. 4, the wheel 14 comprises two annular ends 20 and a plurality of annular recesses 21 and a plurality of annular protrusions 22. The annular protrusions 22 extend radially to the axis A3 towards the outside of the wheel 14. The annular recesses 21 and the annular protrusions 22 are aligned with respect to one another and alternated with respect to one another along the axis A3. Furthermore, the annular recesses 21 and the annular protrusions 22 are arranged between the two annular ends 20. In other words, the wheel 14 comprises a toothed outer surface 23.

The belt 15 comprises a toothed inner face 24 and a smooth outer face 25. According to an alternative embodiment that is not illustrated in the accompanying figures, the outer face 25 is toothed, for instance, with longitudinal or diagonal teeth. The toothed inner face 24 comprises a plurality of annular protrusions 26 and a plurality of annular recesses 27. The annular protrusions 26 are alternated with the annular recesses 27. The annular protrusions 26 extend towards the inside of the belt 15. The toothed inner face 24 of the belt 15 couples with the toothed outer face 23 of the wheel 14 to define a shape coupling. The outer surface 23 of the belt 15 couples with the track 3, in particular with the guides 13. The outer surface 23 of the belt 15 couples with the inner face 30 of the track 3, in particular with the guides 13 and with the cavities.

In use, the support device 9 distributes part of the mass of the tracked vehicle 1 along the traction portion 8 of the track 3, and is able to reduce the vibrations. The reduction of the vibrations results in relatively greater adherence between the wheels 14 and the track 3 which in turn results in relatively better adherence of the track 3 to the ground. This application is particularly useful when the ground is covered in snow. For that purpose, the belt 15 is configured to define a relatively better grip of the wheel 14 on the traction part 8 of the track 3. Since the wheel 14 is not directly in contact with the guide 13, the wheel 14 moves on a surface with less discontinuity and so generates relatively less vibration of said tracked vehicle 1. Reducing the vibrations results in relatively longer life of the suspensions, relatively greater comfort and generally increases the life of the tracked vehicle 1.

According to one embodiment of the present disclosure, each wheel 14 is connected to the beam 17 through a slot so that the distance between the wheels 14 may vary and the tension of the belt 15 can be adjusted.

According to the embodiment illustrated in the accompanying figures, each support device 9 comprises a belt tensioning device 17a arranged between the pair of wheels 14 and connected to the beam 17 so as to be borne by the beam 17. The purpose of the belt tensioning device 17a is to adjust the tension of the belt 15 and maintain a given or designated tension between the pair of wheels 14. According to an alternative embodiment of the present disclosure, the belt tensioning device 17a acts on one of the wheels 14 to change the position of the wheel 14 and adjust the tension of the belt 15 between the respective wheels 14.

According to an embodiment that is not illustrated in the accompanying figures, the support device 9 comprises two rows of wheels 14 arranged on opposite sides of the beam 17 and two belts 15 wound around the wheels 14 of the respective rows.

In particular, the axes of rotation A3 of the wheels 14 of each row have the same distribution pitch and the axes of rotation A3 of the wheels of one row are staggered by a half pitch with respect to the axes of rotation A3 of the wheels 14 of the other row.

In practice, the belt 15 is placed in contact with the transverse elements 10 and is wound around the wheels 14 and kept taut.

According to an alternative embodiment of the present disclosure, one of the wheels 14 of the support device is a drive wheel and the rear wheel 4 is an idle wheel.

The tracked vehicle illustrated herein can be implemented by a production process which implements the tracked vehicle as described above from the beginning of its life. Another method for implementing the tracked vehicle as described above consists of a method of conversion of a tracked vehicle of the type known in certain of the prior art. The method of conversion converts the prior art tracked vehicle into the tracked vehicle of the type described above.

In more detail, the support device 9 is also supplied as a conversion kit for a tracked vehicle to implement the aforesaid method of conversion.

In more detail, the disclosure also relates to a method of conversion of a tracked vehicle having a frame; two front wheels; two rear wheels; two tracks, each of which looped around one of the two rear wheels, and around one of the two front wheels; and at least another pair of support wheels arranged between the rear wheel and the front wheel, and facing towards an inner face of the track.

The method of conversion comprises the step of removing the other pair of support wheels from the tracked vehicle and of coupling the support device 9 to the frame 2 of the tracked vehicle and inside the respective tracks 3. In particular, of coupling two support devices 9 for each track 3. In more detail, the step consists of coupling the beam 17 to the frame 2 by the rotatable coupling 16. Thanks to the method of conversion, a tracked vehicle of the type known in the prior art can be converted using the conversion kit and the conversion method described above into the tracked vehicle of the present disclosure. As a consequence, the tracked vehicle thus modified will be provided with the support devices 9 of the present disclosure which are coupled to the track 3 inside the latter, in order to guarantee better adherence to the ground in particular to the snow and reduce slipping of the track 3.

The scope of protection ofthe present disclosure is defined byte claims which cover variants not specifically described and equivalent embodiments. As such, the present disclosure also covers embodiments not described in the detailed description and equivalent embodiments that fall within scope of the appended claims. Accordingly, various changes and modifications to the presently disclosed embodiments will be apparent to those skilled in the art. Such changes and modifications can be made without departing from the spirit and scope of the present subject matter and without diminishing its intended technical scope. It is therefore intended that such changes and modifications be covered by the appended claims.

The invention claimed is:

1.-18. (canceled)

19. A tracked vehicle support device comprising:
a plurality of support wheels configured to be arranged inside a track of a tracked vehicle between a rear wheel of the tracked vehicle and a front wheel of the tracked vehicle; and
a belt closed in a loop and stretched around the plurality of support wheels, the belt configured to be arranged inside the track of the tracked vehicle, wherein the plurality of support wheels and the belt are configured to form a shape coupling between an inner face of the belt and an outer face of each of the support wheels, wherein an outer face of the belt is configured to be arranged in contact with an inner face of the track of the tracked vehicle.

20. The tracked vehicle support device of claim 19, wherein the plurality of support wheels are formed by a pair of support wheels, and the belt is closed in a loop and stretched around the pair of support wheels.

21. The tracked vehicle support device of claim 19, wherein the plurality of support wheels have a first outside diameter that is comprised between 80% and 135% of a value of an outside diameter of the front wheel of the tracked vehicle.

22. The tracked vehicle support device of claim 19, wherein the plurality of support wheels have a first outside diameter that is comprised between 80% and 130% of a value of an outside diameter of the rear wheel of the tracked vehicle.

23. The tracked vehicle support device of claim 19, wherein each support wheel defines at least one recess which annularly extends around that support wheel to provide the shape coupling.

24. The tracked vehicle support device of claim 19, wherein the belt defines at least one protrusion which extends along the inner face of the belt to provide the shape coupling.

25. The tracked vehicle support device of claim 19, wherein the belt defines a plurality of protrusions evenly distributed along the inner face of the belt and extending longitudinally to the inner face of the belt, and the plurality of support wheels each define a plurality of recesses sized to house at least one of the protrusions and evenly distributed around a rotation axis of that support wheel with a same distribution pitch as that of the protrusions.

26. The tracked vehicle support device of claim 19, further comprising a structure on which the plurality of support wheels are mounted, the structure having a rotatable coupling configured to be connected to a frame of the tracked vehicle.

27. The tracked vehicle support device of claim 26, wherein the plurality of support wheels are formed by a pair of support wheels borne by the structure and mounted at opposite ends of the structure.

28. The tracked vehicle support device of claim 19, wherein the plurality of support wheels are borne by a rocker arm configured to be coupled to a frame of the tracked vehicle.

29. The tracked vehicle support device of claim 19, wherein the belt comprises an elastomeric material.

30. The tracked vehicle support device of claim 19, wherein the outer face of the belt is smooth and configured to be in contact with at least one of: a plurality of transverse metal elements fixed to the track of the tracked vehicle, and a belt of the track of the tracked vehicle.

31. The tracked vehicle support device of claim 19, wherein the plurality of support wheels are made of at least one material selected from a group consisting of: a polytetrafluoroethene material, a metal material, a plastic material, and an elastomeric material.

32. The tracked vehicle support device of claim 19, wherein the track of the tracked vehicle comprises a plurality of guides in contact with the belt and for the plurality of support wheels which are connected to a plurality of transverse metal elements of the track of the tracked vehicle that face towards the inside of the track of the tracked vehicle.

33. The tracked vehicle support device of claim 19, further comprising a belt tensioning device coupled to the belt and configured to adjust a tension of the belt between the plurality of support wheels.

34. A conversion kit for a ski slope preparing tracked vehicle including a rear wheel, a front wheel, and a first plurality of support wheels arranged between the rear wheel and the front wheel and facing towards an inner face of a track, the conversion kit comprising:
a support device including:
a second plurality of support wheels configured to replace the first plurality of support wheels and be arranged inside the track between the rear wheel and the front wheel, and
a belt closed in a loop and stretched around the second plurality of support wheels, the belt configured to be arranged inside the track, wherein the second plurality of support wheels and the belt are configured to form a shape coupling between an inner face of the belt and an outer face of each of the second plurality of support wheels, wherein an outer face of the belt is configured to be arranged in contact with an inner face of the track.

35. A tracked vehicle comprising:
a frame;
a first rear wheel supported by the frame;
a first front wheel supported by the frame;
a first track wound around the first rear wheel and the first front wheel and comprising a first traction portion;
a first support device including:
a first plurality of support wheels arranged inside the first track between the first rear wheel and the first front wheel, and
a first belt closed in a loop and stretched around the first plurality of support wheels, the first belt arranged inside the first track, wherein the first plurality of support wheels and the first belt are configured to form a shape coupling between an inner face of the first belt and an outer face of each of the first plurality of support wheels, wherein an outer face of the first belt is arranged in contact with an inner face of the first track;
a second rear wheel supported by the frame;
a second front wheel supported by the frame;
a second track wound around the second rear wheel and the second front wheel and comprising a second traction portion; and
a second support device including:
a second plurality of support wheels arranged inside the second track between the second rear wheel and the second front wheel, and
a second belt closed in a loop and stretched around the second plurality of support wheels, the second belt arranged inside the second track, wherein the second plurality of support wheels and the second belt are configured to form a shape coupling between an inner face of the second belt and an outer face of each of the second plurality of support wheels, wherein an outer face of the second belt is arranged in contact with an inner face of the second track.

36. A tracked vehicle conversion method comprising:
removing a first plurality of support wheels from a frame of a tracked vehicle;
coupling to the frame of the tracked vehicle a support device comprising a second plurality of support wheels and a belt closed in a loop and stretched around the second plurality of support wheels; and
housing the support device inside a track of the tracked vehicle such that the second plurality of support wheels are arranged inside the track of the tracked vehicle between a rear wheel of the tracked vehicle and a front wheel of the tracked vehicle, the belt is arranged inside the track of the tracked vehicle, the second plurality of support wheels and the belt are configured to form a shape coupling between an inner face of the belt and an outer face of each of the second plurality of support wheels, and an outer face of the belt is configured to be arranged in contact with an inner face of the track of the tracked vehicle.
